(19) United States
(12) Patent Application Publication
(10) Pub. No.: US 2002/0159267 A1
(43) Pub. Date: Oct. 31, 2002

(54) Touch-sensitive switch with brightness-control for lamps

(75) Inventor: Zhiguo Hao, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Shuangqun Zhao

(21) Appl. No.: 10/163,729

(22) PCT Filed: Dec. 9, 1999
(86) PCT No.: PCT/CN99/00204

(51) Int. Cl. F21V 23/04

(52) U.S. Cl. 362/394; 362/84

(57) ABSTRACT

The invention is a touch-sensitive switch with brightness-control for lamps. The switch consists of a switch body and a switch shell. The switch body comprises a brightness-control and touch-sensitive board, a brightness-controlling circuit and a luminous device. A touch-sensitive conductive thin film is on an outer surface of the brightness-control and touch-sensitive board. The luminous device is beneath the brightness-control and touch-sensitive board. Input of the luminous device is connected to output of the brightness-controlling circuit. There are electrode leading wires on the brightness-control and touch-sensitive board, which are serially connected to the brightness-controlling circuit. The switch of the invention is convenient to use and easier to manufacture. It can be used to control the brightness of one or multiple lamps and to function as a position indicator and light for gloomy or dim environments.

### FIELD OF THE INVENTION

The present invention relates generally to a touch-sensitive switch, and more particularly to a touch-sensitive switch with lamp brightness-control combining both brightness-control and lamp on-off control.

### BACKGROUND OF THE INVENTION

At present, there are various kinds of switches in the market. Whether a mechanical type or touch-sensitive type, they are all have only one switching function, that is, to turn on or turn off a lamp. In real life, usually a lamp is used for night or gloomy places, where the switch position is difficult to find. There are switches controlled by voice, but some places or environments are not suitable for voices, such as a home environment at night etc. In these cases, conventional switches without light indication are used.

### SUMMARY OF THE INVENTION

The objective of the invention is to provide a touch-sensitive switch with brightness-control for lamps. The switch has a light hint device, so it not only can be used as a switch, but also can be used as a hint device of switch position and a brightness-control device of a lamp.

Another objective of the invention is to control multiple electrical circuits with one touch-sensitive switch.

The touch-sensitive switch with brightness-control for lamps includes a switch body and a shell. The switch body comprises a brightness-control and touch-sensitive board having opposing outer and inner surfaces, a brightness-controlling circuit and a luminous device. A touch-sensitive conductive film is on the outer surface of the brightness-control and touch-sensitive board. The luminous device is positioned beneath the inner surface of the brightness-control and touch-sensitive board opposite the outer surface on which the touch-sensitive conduction film is present. Input of the luminous device is connected to output of the brightness-controlling circuit. An electrode leading wire serially connects the brightness-control and touch-sensitive board and the brightness-controlling circuit.

The luminous device can be an electroluminescent screen (EL) or other luminous element.

A shielding layer can also be present beneath the inner surface of the brightness-control and touch-sensitive board. Preferably the shielding layer is a conductive thin film on the inner surface (also referred to herein as the underside) of the brightness-control and touch-sensitive board.

The brightness-control and touch-sensitive board can be made of glass, plastic or metal materials.

The electrode leading wire can be connected to the brightness-control and touch-sensitive board by a pressure connection part. The pressure connection part can be connected to the touch-sensitive conductive thin film on the outer surface of the brightness-control and touch-sensitive board and to the conductive thin film on the underside of the brightness-control and touch-sensitive board, respectively.

The touch-sensitive conductive thin film on the outer surface of the brightness-control and touch-sensitive board can be divided into more than one block with electrical isolation. Each of the blocks is connected to its own brightness-controlling circuit. Outputs of the brightness-controlling circuits are connected to the objects to be controlled thereby, respectively.

According to the technical scheme mentioned above, the invention provides a switch, which can be operated conveniently. The switch is easier to manufacture and can be used to control multiple circuits. In addition, the switch can provide touch-sensitive control of the brightness of one or multiple lamps and also can lighten a luminous device automatically at night or in a gloomy environment. In this way, the switch can indicate position and night-brightness functions.

### DRAWINGS OF THE INVENTION

FIG. 1 is an external view of the invention.

FIG. 2 is a diagram of section structure and electrical connection with lamps of the invention.

FIG. 3 is a partially amplified electrode connection structure diagram of the invention.

FIG. 4 is a circuit diagram of the invention.

### EMBODIMENTS OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

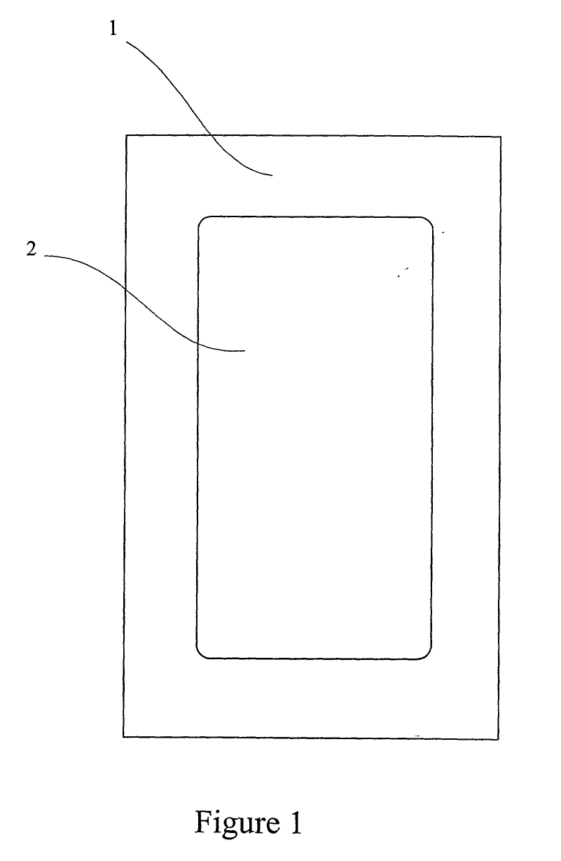

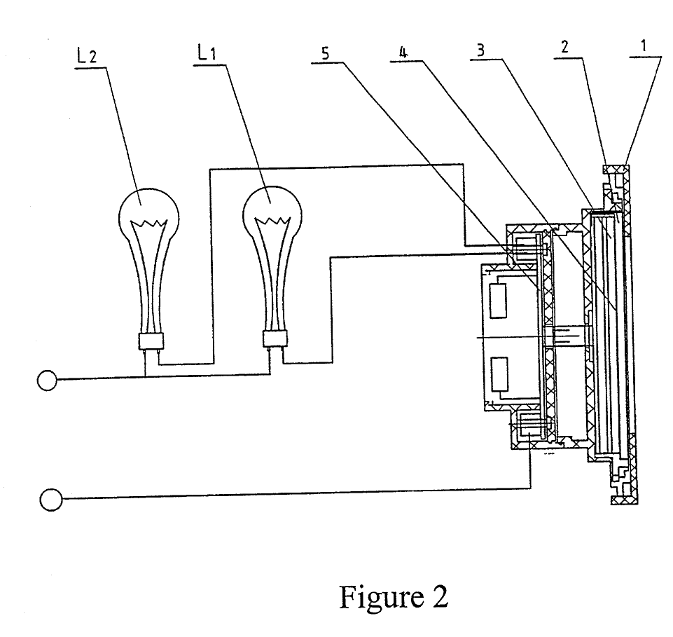

Referring to FIGS. 1, 2, 3 and 4, the invention is a touch-sensitive switch with brightness-control for lamps. The switch includes a brightness-control and touch-sensitive board 2 having opposing outer and inner surfaces, a brightness-controlling circuit and a luminous device. The brightness-control and touch-sensitive board 2 can be mounted in the middle window of fixing panel shell 1. A touch-sensitive conductive thin film is on the outer surface of brightness-control and touch-sensitive board 2. The brightness-control and touch-sensitive board 2 can be made of glass, plastic or metal material. The luminous device can be an electroluminescent screen (EL) 3 or other luminous element, such as a light emitting diode etc., and is positioned beneath the inner surface of the brightness-control and touch-sensitive board 2. Output of the brightness-controlling circuit can be serially connected with a lamp.

In a gloomy or dim environment, the light-control element GM conducts the transistor T, luminescent screen circuit a, b is turned on and the luminescent screen EL is lighted automatically. In a gloomy or dim environment with this little light, not only is the switch position shown, but also some illumination is provided, which can be particularly useful at night. When lighting is needed, one can touch the brightness-control and touch-sensitive board 2 to turn on a lamp immediately. At the same time, the light-control element GM cuts off the transistor T, then luminescent screen circuit a, b is turned off and the luminescent screen EL is put out. The lamp brightness-controlling circuit is basically the same as the touch-sensitive control circuit of present technology, and will not be described here. With the invention, the brightness can be controlled from strong to weak or from weak to strong gradually without steps. To turn off the lamp smoothly, one can touch the brightness-control and touch-sensitive board 2. If it is gloomy or dim at this moment, then light-controlled element GM lights the luminescent screen EL again.

A shielding layer 4 can be positioned under the brightness-control and touch-sensitive board 2. When the distance between luminescent screen 3 and brightness-control and touch-sensitive board 2 is small, luminescent screen 3, which is working under a voltage and a frequency such as 220 V and 50 Hz, will cause an error action on the touch-sensitive conductive thin film on the surface of the brightness-control and touch-sensitive board 2. The shielding layer 4 is to shield alternating current on luminescent screen EL 3 which could interfere with the on-off performance of the brightness-control and touch-sensitive board 2. In this way, the size of the switch is small and the switch works normally. In one embodiment, the shielding layer 4 is the conductive thin film layer on the underside of the brightness-control and touch-sensitive board 2. This can satisfy the requirement for transparency and reduce the size of the switch without adding an additional shielding device.

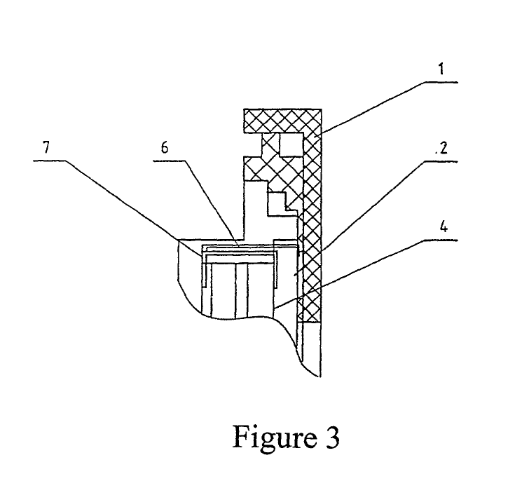

The touch-sensitive conductive thin film on the upper surface of the brightness-control and touch-sensitive board 2 is for touch-sensitive conducting, and the conductive thin film on the underside surface of the brightness-control and touch-sensitive board is for shielding and grounding. Therefore, connection between the electrode leading wire and the brightness-control and touch-sensitive board 2 can be a pressure connection part, which connects the touch-sensitive conductive thin film on the upper surface of the brightness-control and touch-sensitive board and the conductive thin film on the underside surface of the brightness-control and touch-sensitive board 2, respectively. FIG. 3 shows one touch-sensitive pressure end 6 pressingly connected with the touch-sensitive conductive thin film on the upper surface of the brightness-control and touch-sensitive board 2, and another touch-sensitive pressure end 7 pressingly connected with the ground-connected shielding layer 4. The connections of the electrode leading wire are completed conveniently and reliably. This not only improves the efficiency of manufacture, but also increases the conductive reliability of the switch.

When the underside conductive thin film of the brightness-control and touch-sensitive board 2 is the shielding layer 4, it can be connected to the negative end of the control circuit. In this case, when the brightness-control and touch-sensitive board 2 is broken, the touch-sensitive surface of the brightness-control and touch-sensitive board 2 and the underside conductive thin film of the brightness-control and touch-sensitive board 2 are all broken too. Consequently, the shielding layer 4 is broken, the electrical connection of the brightness-control and touch-sensitive board 2 is turnoff, there is no voltage on the brightness-control and touch-sensitive board 2, so it is safe for application.

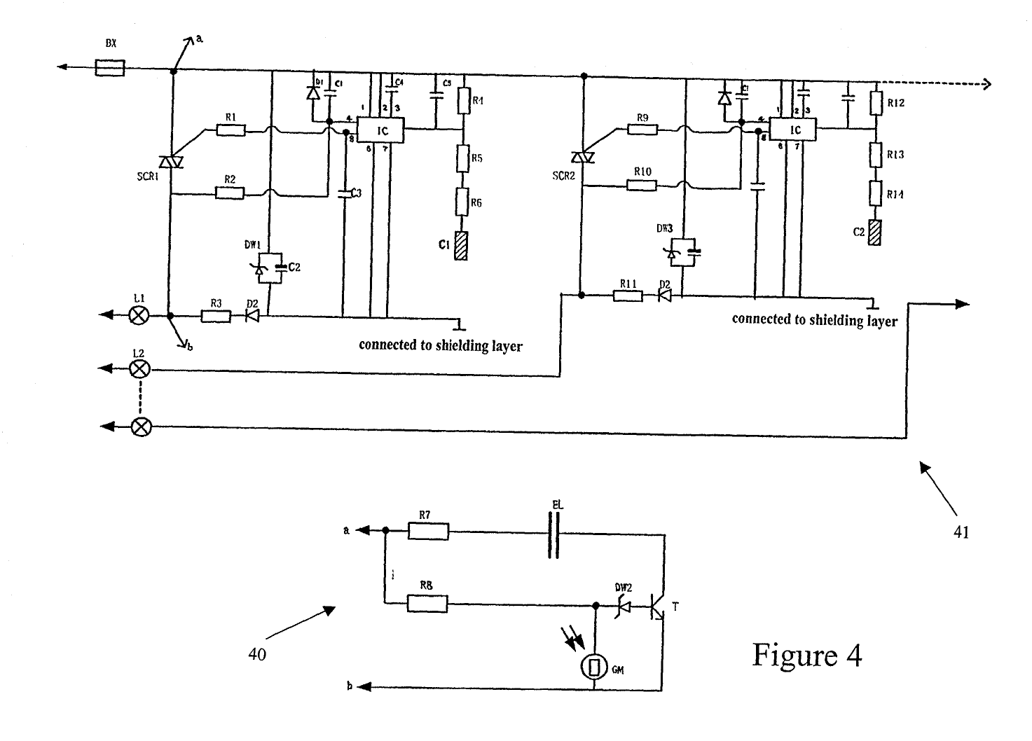

In order to allow one switch to control multiple circuits, the brightness-control and touch-sensitive board 2 is divided into more than one block by electrical isolation and they are kept as a whole, i.e. the brightness-control and touch-sensitive board 2 is still an unit, but the touch-sensitive conductive thin film is divided into more than one block. Each block is serially connected to a control circuit, respectively, and outputs of the control circuits are connected to the objects controlled thereby, respectively. FIG. 4 is a brightness-controlling circuit diagram, which includes two parts: a luminescent screen brightness-controlling circuit 40, and an on-off and brightness-controlling circuit 41 connected to the brightness-control and touch-sensitive board 2. Luminescent screen EL input is controlled by light-controlled element GM. When a part of the brightness-control and touch-sensitive board 2 is touched, the lamp connected to the part is lighted, and the brightness of the lamp can be adjusted. Accordingly the switch allows a user to turn on one or multiple lamps. FIG. 4 shows that lamps L1 and L2 are controlled by two electrically isolated parts of the brightness-control and touch-sensitive board 2 C1 and C2, respectively. Touching C1, lamp L1 will turn on, and touching C2, L2 will turn on, and touching C1 and C2, lamps L1 and L2 can be turned on simultaneously or sequentially.

Many modifications and other embodiments of the invention will come to mind to one skilled in the art to which this invention pertains having the benefit of the teachings presented in the foregoung descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a genereric and descriptive sense only and not for purposed of limitation.

1. A touch-sensitive switch with brightness-control for lamps comprising a switch body and a switch shell, the switch body comprising:
a brightness-control and touch-sensitive board having an outer surface and a inner surface;
a brightness-controlling circuit;
a luminous device beneath the inner surface of the brightness-control and touch-sensitive board, wherein input of the luminous device is connected to output of the brightness-controlling circuit;
a touch-sensitive conductive thin film on the outer surface of the brightness-control and touch-sensitive board; and
electrode leading wires serially connecting the brightness-control and touch-sensitive board and the brightness-controlling circuit.

2. The switch according to claim 1, wherein the luminous device is an electroluminescent screen (EL) or other luminous element.

3. The switch according to claim 1, further comprising a shielding layer beneath the inner surface of the brightness-control and touch-sensitive board.

4. The switch according to claim 3, wherein the shielding layer is a conductive thin film on the inner surface of the brightness-control and touch-sensitive board.

5. The switch according to claim 1, wherein the brightness-control and touch-sensitive board is made of glass, plastic or metal material.

6. The switch according to claim 4, further comprising a connection part connecting the electrode leading wires and the brightness-control and touch-sensitive board, wherein the connection part is a pressure connection part connected to the touch-sensitive conductive thin film on the outer surface of the brightness-control and touch-sensitive board and the conductive thin film shielding layer on the inner surface of the brightness-control and touch-sensitive board.

7. The switch according to claim 1, wherein the touch-sensitive conductive thin film on the outer surface of the brightness-control and touch-sensitive board is divided into more than one isolated block, wherein each block is serially connected to a brightness-controlling circuit and wherein the output of each brightness-controlling circuit is connected to an object to be controlled thereby.
